(19) United States
(12) Patent Application Publication
(10) Pub. No.: US 2023/0151269 A1
(43) Pub. Date: May 18, 2023

(54) FABRICATION OF THE SURFACE CONTROLLED QUANTUM DOTS ALLOWING THE SIZE ADJUSTMENT AND THEREOF

(71) Applicant: ISTANBUL SABAHATTIN ZAIM ÜNIVERSITESI, Istanbul (TR)

(72) Inventor: Osman ARSLAN, Istanbul (TR)

(73) Assignee: ISTANBUL SABAHATTIN ZAIM ÜNIVERSITESI, Istanbul (TR)

(21) Appl. No.: 17/917,342

(22) PCT Filed: Apr. 30, 2020
(86) PCT No.: PCT/TR2020/050363

§ 371 Date: Oct. 6, 2022

(30) Foreign Application Priority Data
Apr. 7, 2020 (TR) 2020/05537

(51) Int. Cl. C09K 11/02

(52) U.S. Cl. CPC C09K 11/025; B82Y 40/00

(57) ABSTRACT

The synthesis of quantum dots, whose surface and quantum dot size can be controlled as desired, can be stored in different solvents or solid without prolonged degradation, agglomeration and can be transferred to water from organic solvents by means of phase transfer reaction which means can be made water-soluble. The optical properties are related to the production of quantum dots, the size of the quantum dots is controlled with surface. Obtained quantum dots are ready to produce in large amounts and can take places of sensors, nanomaterial applications, florescent applications.

### TECHNICAL AREA

The present invention gives a description about the quantum dots which can be obtained with a surface control and size adjustment between the 1-10 nm range. These dots are natural photoluminescence sensor due to the relevant and desired photoluminescence features, containing bidendate ligands on the quantum dot surface. This surface control is based on the precursor reactant and the output material which its size is brought to the desired ranges under controlled growth conditions due to the special carboxylic acid-based metal complexes. Therefore the invention deals with the fabrication of quantum dots that can be used for many different applications in hydrophilic and hydrophobic environments.

### BACKGROUND OF THE INVENTION

Quantum dots are widely utilized due to their nanoelectronic, nanooptic, nanocomposite and nanochemical effects in single and multiple aim applications. Especially studies and interest to these kind of nanoparticles or quantum dots are highly peaking. Usually if the structures are called nanoparticles this means that mostly the sizes for particles are in the range of 10-200 (or 50-900 nm) nm. However, the most salient feature that distinguishes quantum dots from other simple particles or other disciplines is the increase in surface/volume (NV) ratios of ultrasmall sized nanomaterials. Also it is difficult to observe nano or quantum regime effects due to misinterpretation of this surface/volume ratio since nanoparticles which are greater than 10 nm, the size effects varies abruptly. Therefore, the size of the particles around 1-10 nm provides an easiness and it is widespread to observe quantum effects, in other words, nanotechnological quantum confinement effects on these dots. While the structures, especially in the class called semiconductors, require focusing on the term band gap energy, observations can be realized if from a metal particle with plasmonic effect of around 1-10 nm. While quantum structures can be obtained by optical and electronic nanoscale, biological labeling, solar cells, Li batteries, LED systems and many other applications can also be achieved.

In current state, fabrication of the nanomaterials containing nanoparticle and quantum dots, generally use the bottom-up technique especially for quantum particles, II-VI structures in the semiconductor category such as ZnSe or ZnS CdSe, CdS. Additionally Hydrothermal/Solvothermal method and Hot Injection synthesis method were emerged in recent years. Quantum particles generally have a very large surface area due to their small size, and therefore quantum activities arising from the surface need to be kept under control. For example, semiconductor structure produces electron-hole pair and they undergoes short recombination times due to the huge surface effects. The main reason for this situation is crystalline defects or unsaturated electron structures on the surface which may be varied with different tools.

The necessity of protecting the surface of inorganic quantum particle crystals is required for protecting the optical and chemical properties, as well as to prevent agglomeration of particles due to unsaturated atoms on the surface. The surface passivation of the quantum dot can be realized by core/shell method, multiple shell structures, protective agents, polymer materials attached to the surface for preventing the electron-space recombination while also benefiting for high quantum yields. Hence, agglomeration is a situation that can be prevented by passivating the surface and thic action can be accomplished by surface modification. Surface modification protects the particle/quantum dot surface from external factors with different number of dendat structures adhered to the surface and also controls the quantum efficiency.

Surface modification procedure is generally accomplished by considering the atoms present on the surface. Basically whole operation is a hard acid hard base approach. At this stage, the surface modifier ligand on the surface is bonded with covalent bonds. This ligand can then be attached to a specific biological group in any biological system or modified to match the interface in structures that require hardness or to be used as nanomaterials, such as nanocomposites.

As a bottom up method, the Hot Injection method can provide very good monodispersity properties and very high quantum yields in quantum dots especially in chalcogenide structures. During the synthesis of the quantum dots, nucleation and growth stages based on La-Mer theory emerges and control of these stages becomes prominently significant. Therefore, controlled organometallic solutions in relatively hot solutions can provide a homogeneous nucleation and growth in a short time, especially with controlled parameters.

It is widely known from the Bawendi method that, organometallic precursors are readily utilized with cadmium and zinc-based metals for a homogeneous reaction at high temperatures. Besides phosphine or phosphine oxide type of ligands directly affect the final forms of nanocrystals or quantum dots to be obtained by providing surface modification. Since the toxicological effects of metals such as cadmium, mercury are very harmful on a molecular basis which indirectly forces us the use of green (harmless to nature) methods and chemicals which should be emphasized during the synthesis phase. In this way, instead of syntheses started with relatively expensive ligands and precursors especially at high temperatures, the quantum dot production should be prominent and water-based or low energy techniques and methods must be highlighted. Considering these points, the most desired situation in this quantum dot production is to separate the nucleation and growth stages from each other to obtain monodispersed quantum dots. Aiming for this separation, nucleation is initiated when one or two reagents are injected separately into the reaction flask at high or proper temperatures. However, since the solutions of the starting reagents injected for nucleation are quite cold, the temperature of the environment decreases rapidly. Therefore, nucleation stops or, in other words, nucleation occurs in a very short interval. This results in a small, monodisperse particle/quantum dot size range. Small and monodisperse nuclei grow with surface reactions or Ostwald growth. It is obvious that the synthesis of high volume or large scale synthesis in this technical situation will cause great problems. Temperature differences will be uncontrollable, high quantities of quantum dot production are inefficient and since nucleation will be different from different regions of the solution, it will grow with a non-homogeneous behaviour and different structures are obtained instead of monodisperse growth.

The patent document numbered U.S. Pat. No. 7,482,382B2 states that for a metal oxide quantum dots, zincacetate based initiators and alcohol-based solution are prepared for quantum dot synthesis and obtained quantum dots are accomplished with a sol-gel method. These structures show agglomeration, therefore PL features should be shifting since there is no surface control.

The content of the invention is composed of a metal carboxylate reagent producing a quantum particle (between 1-8 nm) alone or in combination with different metal compounds for small doping attempts. Additionally a basic environment without the need of high temperature is necessary. While performing this reaction, surface modification occurs naturally and can be easily determined by the NMR or FT-IR method. Thus, the growing quantum dots are developed in a controlled manner depending on the reaction conditions which is controlled by PL or UV-Vis absorption properties.

The present invention describes metal oxide quantum dots, the sizes of which can be adjusted and prepared up to 1-10 nm, containing bidendate ligands on the surface based on the starting material. When the starting material is brought to the desired size under controlled growth conditions due to the fact that it is specially carboxylic acid-based metal complexes, the relevant and desired photoluminescence feature is also obtained. Thus, it can be used as photoluminescent sensors. Therefore, the photoluminescence sensor can find applications in different fields such as teranostic, nanoelectronic, light absorption applications. When the molecular structure on the surface is controlled, photons that can selectively catalyze organic structures can be produced. In addition, it has the ability to absorb selectively in the UV—(Visible)—visible region.

The structural and characteristic features and all the advantages of the invention will be more clearly understood by the detailed explanation below with supporting Figures and measurements.

### FIGURES TO HELP DESCRIBE THE INVENTION

FIG. 1: NMR Long carboxylate chains onto the synthesized quantum dots

FIG. 2: FTIR Peaks of the long carboxylate chains on quantum dots

FIG. 3: TEM image of agglomeration free quantum dots

FIG. 4: XRD Crystalline features of the synthesized quantum dots

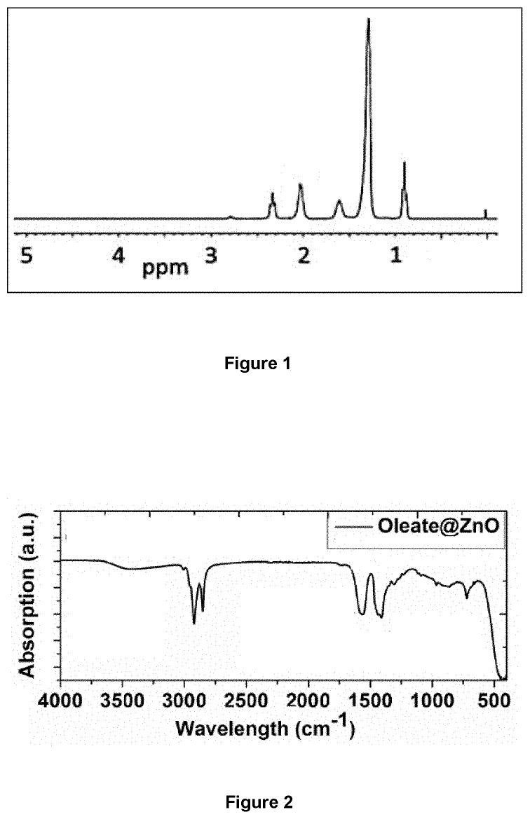

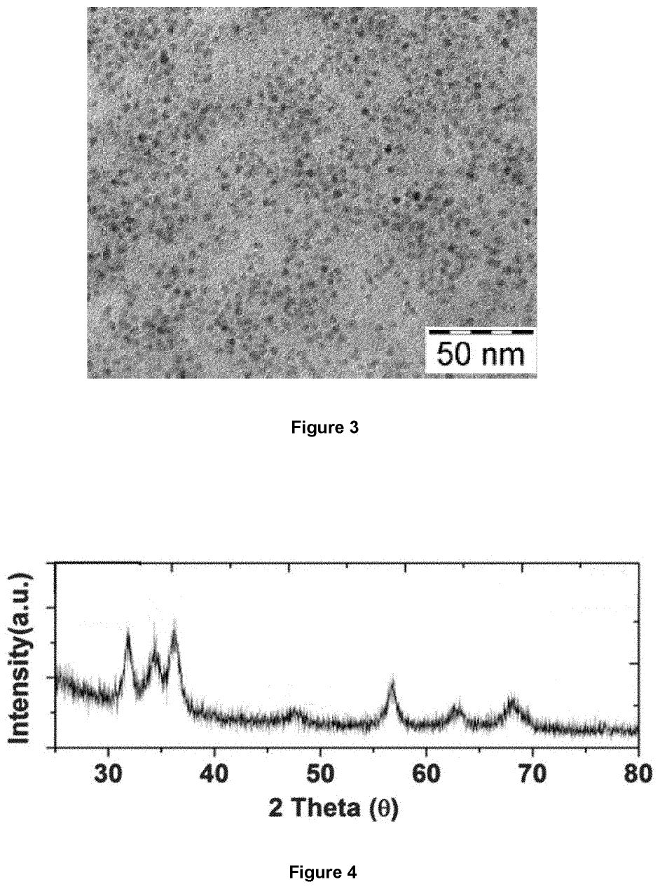

### DETAILED DESCRIPTION OF THE INVENTION

In this detailed description, the present invention is described in such a way that the size-controlled and surface-controlled quantum particles can be produced without any negative effect on production.

In this invention quantum particle sizes (between 1-8 nm) can be controlled as desired, also can be stored without change in size and emission in different solvents or solid without long-term degradation without agglomeration, and can be transferred to water from organic solvents and made water-soluble at any time.

With the present invention, it is ensured that the particle size is controlled within a precise range with controlled features. The particles are round and generally fabricated by thermodynamic control. Since surface modification is automatically provided at the end of this method, its optical properties are also under control. Quantum dots can be produced in alcoholic solutions or partially aqueous solutions if desired. The added amount of water helps to increase the size of the quantum dots to be obtained.

The quantum particles obtained are free from agglomeration as evidenced by TEM (Transmission Electron Microscopy) analysis. This is because the used starting ligand used is properly attached to the surface during the synthesis and provides a steric effect when growth ends. By this steric effect, quantum dots do not show agglomeration when compared to other quantum dots of the same size. Thus, phase transfer is possible after the dots are obtained. Quantum dots, which are hydrophobic in nature can be converted into hydrophilic and it can be stored in long terms. It is demonstrated that the obtained quantum dots do not show agglomeration at the rate monitored for 1 year. After storage, only the desired composition is revealed by atomic analysis. In this way, the crystal structure; inclusion of other atoms is prevented.

Synthesis conditions can be performed in the desired environment. Generally, processes are performed with atmospheric environments and relatively low temperatures (room temperature or 90° C.). In addition, it has been proved by XRD studies that the crystal structure is more clear as the temperature increases. The solvent in the medium is usually alcohol based, which contains small numbers of carbon. In this way, extremely reactive and extreme basic environments can be prepared. If desired, reagents can be added together or separately. As the temperature increases, all components dissolve better, so the initial stages of nucleation can be under control.

If we evaluate the ratios of the reagents used, the different reagent ratios create different starting solution characters and contribute to the particle growth. Highly basic environments can be directed as desired in the first 15-60 minutes, which is called as chaotic period. For this reason, basic initiators in different proportions are added to the metal complex, which is generally used as the beginning. Alcohols or alcohol mixtures can be used as reaction environments. The addition of small amounts of water increases the growth rate. It is observed that monodispersity is generally provided in all cases.

In order to obtain single atom and oxygen containing quantum dots, the starting metal complex is usually refluxed for a certain of period of time in the basic medium. Basic forming metals can generally be used as Na, Li, K and even Rb hydroxides. Long chain carboxylate derivatives of common transition elements can be used as metal initiators. Preferably long chain ones are preferred. When different agents with different properties (Lewis acid or some) are added into the solvent, the quantum sizes can be developed and controlled based on proportions.

The reaction steps can be monitored by a suitable method. PL or UV-Vis spectroscopy is vastly utilized because they are quite easy methods for detection. As the reaction time increases and quantum dots grow, small quantities of samples provide important information about quantum dot development and particle size. Emission wavelengths or absorption wavelenghts can usually be detected for the reaction steps by increasing emission of wavelengths in PL spectroscopy. After the synthesis of quantum dots is finished, cold separation can be performed and the sample can be dried by removing solvent molecules at relatively low temperatures.

In this invention, generally, long chain fatty acids, for example, hexadecanoic acid, oleic acid, as well as saturated or unsaturated carboxylic acid structures with carbon numbers of 6-20 are used. In addition to this content, small amounts of methanol, ethanol, propanol, isopropanol and solvents such as different solvents or mixtures are used with water. In these environments, Mg (OH) 2, Ba (OH) 2 are used as examples of alkali metal bases and other strong base structures. Metal salt structures, especially Ti, Cr, Mn, Zn, especially transition metals, can be used here for doping of different atoms. Different time and shape results can be observed due to valence electron structures and d orbital contents.

The ratios of reagent amounts and the amounts of metal salts used specifically for the synthesis process and also to control the particle size in a variable manner. For example, ratios by weight for the synthesis process;
Solutions: in the 50-75% range,
Initiator metal carboxylate: 10-25%,
The pH adjuster is in the range of 0.1-5%.

In this process, the compositions vary depending on the properties of the product to be obtained.

In the present invention, solid materials are used for the mixture. The input materials are in powder form and are mixed with solvents in a subsequent processes. Solid structures are dissolved separately in solvents to obtain products. If desired, they can be mixed at the same time. This dissolving process can enable different amounts of solvent to be used separately with different amounts of solids. Particularly, the compounds prepared in the solvent are mixed with each other and reflux should be performed at 50° C. or other different temperatures varying till 90° C. and reflux can be continued for different timelines like 30 minutes to 5 days.

As can be seen in FIG. 1, quantum particles can be obtained agglomeration free with initial ratios and can be stored without agglomeration for a longtime due to the surface protection.

Due to the nature of the invention, the side effects of agglomeration and sticking together quantum dots with deviated fluorescence features are eliminated. Especially considering the size of the quantum dots, it allows to synthesize quantum dots that can be stored for a long time and radiate in the visible region with deep control.

It is clear that a skilled person in the chemistry/material technology can demonstrate the novelty of the invention using similar embodiments and/or apply it to other areas of similar purpose. It is therefore clear that such embodiments will be produced based on the similar innovation technique.

1-7. (canceled)

8. A method for fabricating quantum dots comprising:
ensuring that the quantum dots are quantum sizes by using different reagents;
slowing growth of the quantum dots in a controlled manner wherein the quantum dots can be stored for long periods,
synthesising the quantum dots through radiation in the visible region, so that the quantum dots are size-adjustable and surface-controlled, wherein;
the dots are obtained through mixing the different reagents in different ratios as solids and through reflux of products at different temperatures, and different reagents are be made through dissolving solids separately in solvents, and
further comprising heat treating the quantum dots by mixing the different reagents with each other, wherein large amounts of size controlled dots in a precise range or close to the specified range, which can be stored for long periods of time, are transferred from organic solvents to water and become water-soluble through phase transfer reaction, and can radiate in the visible region.

9. The method of claim 8, further comprising;
dissolving the separate solid structures used for mixing in the solvents, and
using different proportions of the solvent with different amounts of the solids,
wherein the mixture of the compounds prepared separately in solvents with each other are exposed to reflux in atmospheric environments, and are heat treated at between 50° C. and 90° C. and for 30 minutes to 5 days.

10. The method of claim 8, wherein the solvents are one of long chain fatty acids, saturated or unsaturated carboxylic acid structures with carbon number 6-20, solvents with small carbon numbers such as methanol, ethanol, propanol, isopropanol or trace amounts of different solvents or mixtures with water.

11. The method of claim 8, further comprising obtaining single quantum dots using at least one of alkalinity forming metals Na, Li, K or Rb; hydroxides; or long chain carboxylate derivatives of general transition elements, wherein reflux is realized for certain periods in an initiator metal complex basic solution, wherein the initiator metal complex is a long chain metal initiator, and the size of the quantum dots is developed based on the different agents having different properties that are added into the solvent.

12. The method of claim 9, wherein the solution used for a synthesis process contains solvents in the range of 50-75%, an initiator metal ester in the range of 10-25%, and a pH adjuster in the range of 0.1-5%.

13. The method of claim 8, further comprising transforming the quantum dots from hydrophobic to hydrophilic by attaching a starting ligand to the surface during synthesis.

14. The method of claim 8, further comprising using UV-Vis spectroscopy to calculate the surface properties of the quantum dots, whose growth characteristics can be followed to realize growth characteristics.
